(19) United States
(12) Patent Application Publication
(10) Pub. No.: US 2008/0267649 A1
(43) Pub. Date: Oct. 30, 2008

(54) Image Forming Apparatus and Image Forming Method

(75) Inventors: Mikio FURUMIZU, Matsumoto-shi (JP); Nobuyuki MIZUSHIMA, Shiojiri-shi (JP); Makoto MATSUSHITA, Sennan-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 11/953,545

(22) Filed: Dec. 10, 2007

(30) Foreign Application Priority Data
Dec. 11, 2006 (JP) 2006-333143

(51) Int. Cl. G03G 15/16

(52) U.S. Cl. 399/66

(57) ABSTRACT

An image forming apparatus includes: an image supporting member; a charging member charging the image supporting member; an image forming member forming a latent image on the image supporting member; a developer supporting member developing the latent image on the image supporting member; a transfer member to which the developed image is transferred; a charging bias controller applying a charging bias immediately before a position at which the image is formed on the image supporting member in a printing operation passes the charging member; and a transfer bias controller applying a transfer bias immediately before the position at which the image is formed on the image supporting member in the printing operation reaches a nip portion between the image supporting member and the transfer member.

### BACKGROUND

1. Technical Field

The present invention relates to an image forming apparatus transferring an image formed on an image supporting member and an image forming method.

2. Related Art

Generally, an electrographic type toner image forming unit includes a photosensitive member, which is an image supporting member, having a photosensitive layer on the outer circumference surface of the photosensitive member, a charging member uniformly charging the outer circumference surface of the photosensitive member, an exposure member selectively exposing the circumference surface uniformly charged by the charging member to form an electrostatic latent image, and a development member forming an optical image (toner image) by applying toner, which is a development material, to the electrostatic latent image formed by the exposure member.

A rotary-type image forming apparatus that forms a color image arranges the above-described toner image forming unit for a first transfer belt. There is a known image forming apparatus that sequentially transfers a toner image on the photosensitive member by the toner image forming unit on the first transfer belt and overlaps the toner image of a plurality of colors (for example, yellow, cyan, magenta, and black) on the first transfer belt to obtain a color image on the first transfer belt.

In the past, a known image forming apparatus included a transfer belt transferring images formed on the photosensitive member. However, in such an image forming apparatus, a slight difference between a speed of the photosensitive member and a speed of the transfer belt may be accumulated and positional variation between the photosensitive member and the transfer belt may occur. Moreover, in a case of transferring multiple-color toner, registration deviation (color deviation) shown in FIG. 6 may occur.

Therefore, in order to avoid this problems, there was provided an image forming apparatus that could prevent friction caused between the photosensitive member and the transfer belt from increasing or prevent the position from deviating by applying a transfer bias at the time a first transferring operation of the toner image from a photosensitive member onto the transfer belt is performed immediately before the front end of the toner image reaches the transfer position (see JP-A-11-218994).

However, the registration deviation may not be sufficiently reduced in accordance with the image forming apparatus disclosed in JP-A-11-218994.

### SUMMARY

An advantage of some aspects of the invention is that it provides an image forming apparatus and an image forming method capable of reducing registration deviation and maintaining high transfer efficiency to obtain a high-quality image, and furthermore achieving low power consumption.

According to an aspect of the invention, there is provided an image forming apparatus including: an image supporting member; a charging member charging the image supporting member; an image forming member forming a latent image on the image supporting member; a developer supporting member developing the latent image on the image supporting member; a transfer member to which the developed image is transferred; a charging bias controller applying a charging bias immediately before a position at which the image is formed on the image supporting member in a printing operation passes the charging member; and a transfer bias controller applying a transfer bias immediately before the position at which the image is formed on the image supporting member in the printing operation reaches a nip portion between the image supporting member and the transfer member. As a result, it is possible to reduce the registration deviation, maintain high transfer efficiency, and obtain a high-quality image by suppressing electrostatic absorption.

In the image formation apparatus with the above-described configuration, the charging bias controller may apply a first charging bias in advance and applies a second charging bias larger than the first charging bias immediately before the position at which the image is formed on the image supporting member in the printing operation passes the charging member. Accordingly, the image remaining on the image supporting member can be eliminated before the transfer bias is turned ON. As a result, it is possible to obtain the high-quality image and also achieve low power consumption.

In the image formation apparatus with the above-described configuration, the transfer bias controller may apply a first transfer bias in advance and applies a second transfer bias larger than the first transfer bias immediately before the position at which the image is formed on the image supporting member in the printing operation reaches the nip portion between the image supporting member and the transfer member. As a result, since the power supply is stabilized, it is possible to obtain the high-quality image and also achieve low power consumption.

The image formation apparatus with the above-described configuration may further include an image forming controller performing an exposing operation to the image forming member in advance immediate before the position at which the image is formed on the image supporting member in the printing operation passes the image forming member. Accordingly, the photosensitive member charged in advance in the printing operation, a difference in potential with the transfer member is reduced, the electrostatic absorption is suppressed, and the transfer efficiency is improved. As a result, it is possible to obtain the high-quality image.

In the image formation apparatus with the above-described configuration, the transfer member may be formed of a transfer belt with two or more layers. Accordingly, minute gap discharge before the transfer operation is suppressed, the transfer electric field is sufficiently applied, and the transfer efficiency is improved. As a result, it is possible to obtain the high-quality image.

In the image formation apparatus with the above-described configuration, the transfer member may have an innermost layer on the inside, an outermost layer on the outside, and an intermediate layer between the innermost layer and the outermost layer, and resistance values of the layers of the transfer member may satisfy a resistance value relation of the innermost layer>the outermost layer>the intermediate layer. Accordingly, the transfer efficiency is further improved, and therefore it is possible to obtain the high-quality image.

### BRIEF DESCRIPTION OF THE DRAWINGS

The invention will be described with reference to the accompanying drawings, wherein like numbers reference like elements.

FIG. 1 is a vertically sectional side view illustrating an image forming apparatus according to a first embodiment.

FIG. 2 is a sectional view illustrating a first transfer belt according to the first embodiment.

FIG. 3 is a diagram illustrating timing charts according to the first embodiment.

FIG. 4 is a diagram showing registration deviation of comparative examples and the first embodiment.

FIG. 5 is a diagram illustrating timing charts according to a second embodiment.

FIG. 6 is a diagram illustrating the registration deviation in a known example.

### DESCRIPTION OF EXEMPLARY EMBODIMENTS

Hereinafter, embodiments of the invention will be described with reference to the drawings.

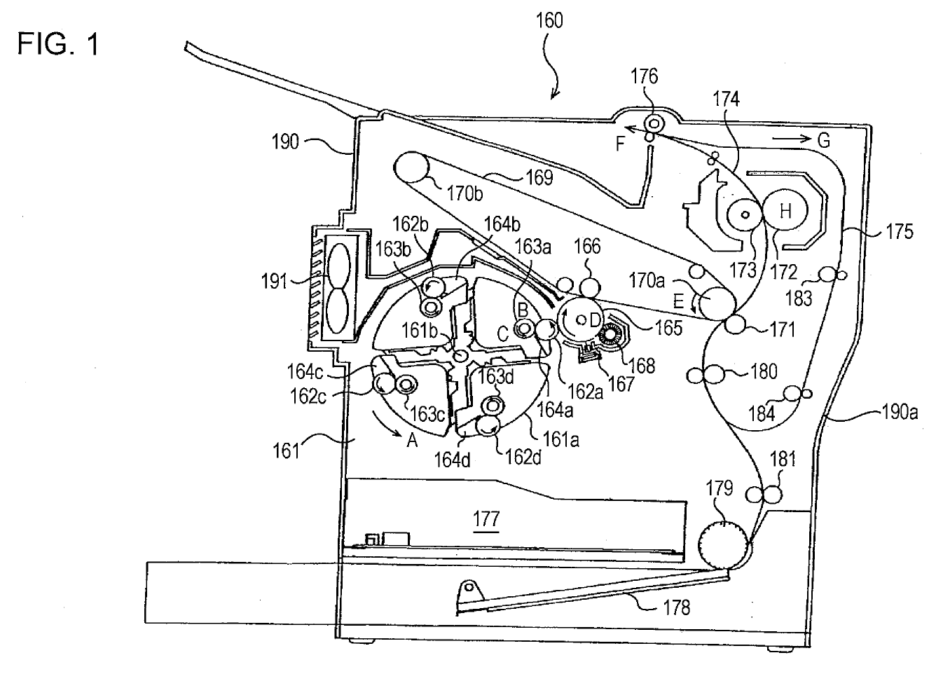

FIG. 1 is a vertically sectional side view illustrating an image forming apparatus according to a first embodiment. As shown in FIG. 1, an image formation apparatus 160 includes a rotary development device 161, a photosensitive drum 165 serving as an image supporting member, an image forming member (exposure member) 167 having a line head using a light-emitting element such as an organic EL array or a scanning optical system using a laser beam as a light source and the like, a first transfer belt 169 as a first transfer member, a sheet transporting passage 174, a heating roller 172 of a fixing unit, and a feeding tray 178.

In the development device 161, a development rotary 161a rotates in an arrow A direction about a shaft 161b. The inner part of the development rotary 161a are divided into 4 portions and image forming units of four colors of yellow (Y), cyan (C), magenta (M), and black (K) are provided. Reference Numerals 162a to 162d denote development rollers as toner supporting member which are disposed in each of the image forming units and rotate in an arrow B direction. Reference Numerals 163a to 163d denote toner supply rollers that rotate in an arrow C direction. In addition, Reference Numerals 164a to 164d are regulation blades that regulate with a predetermined thickness.

The photosensitive drum 165 is driven in an arrow D direction, which is opposite a direction in which the development roller 162a rotates, by a driving motor (not shown), for example, a step motor. A first transfer belt 169 is suspended between a driven roller 170b and a driving roller 170a. The driving roller 170a is connected to the photosensitive drum 165 so as to supply power to the first transfer belt 169. The driving roller 170a of the first transfer belt 169 rotates an arrow E direction, which is opposite a direction in which the photosensitive drum 165 rotates, by the drive of the corresponding driving motor.

Operations from the development device 161 to the first transfer belt 169 of the image forming apparatus 160 will be described. First, toner is supplied from the toner supply rollers 163a to 163d to the development rollers 162a to 162d. At this time, an amount of toner is adjusted by the regulation blades 164a to 164d. The development rollers 162, which are charged by a charging member 168, develop a latent image formed by a line head 167 on the photosensitive drum 165. The image on the photosensitive drum 165 is transferred to the first transfer belt 169.

A plural pairs of transport rollers and discharge rollers 176 and the like are provided in the sheet transporting passage 174 so as to transport a paper sheet. The image (toner image) supported on the first transfer belt 169 is transferred onto one side of the paper sheet at a position of a second transfer roller 171. The second transfer roller 171 comes in contact with the first transfer belt 169 or is separated from the first transfer belt 169 by a clutch. In addition, when the clutch is turned ON the second transfer roller 171 comes in contact with the first transfer belt 169 so that the image is transferred onto the paper sheet.

The paper sheet on which the image is transferred in this way is subjected to a fixing operation by the fixing unit having a fixing heater H described above. The fixing unit has a heating roller 172 and a pressurizing roller 173 with an inverse crown shape. The paper subjected to the fixing operation is inserted between the pair of discharge rollers 176 so as to move in an arrow F direction. At this time, when the pair of discharge rollers 176 rotate in a reverse direction, the direction of the paper sheet is reversed so as to move toward a both-surface printing transporting passage 175 (both-surface transport passage) in an arrow G direction. Reference Numerals 183 and 184 denote a first both-surface roller and a second both-surface roller. Reference Numeral 177 denotes an electrical component box, Reference Numeral 178 denotes a feeding tray for receiving paper sheets, and Reference Numeral 179 denotes a pick-up roller provided in an exit of the feeding tray 178. An exhausting pan 191 is disposed in a housing case 190. An opening/closing member 190a for taking out the paper sheet in a case where the paper sheet is jammed is disposed on the side of the sheet transporting passage 174 of the housing case 190.

When viewed from the sheet transporting direction of the pick-up roller 179, feed rollers 181 are formed on the downstream side of the sheet transporting passage 174. In addition, gate rollers 180 are formed on the upstream side of the second transfer roller 171.

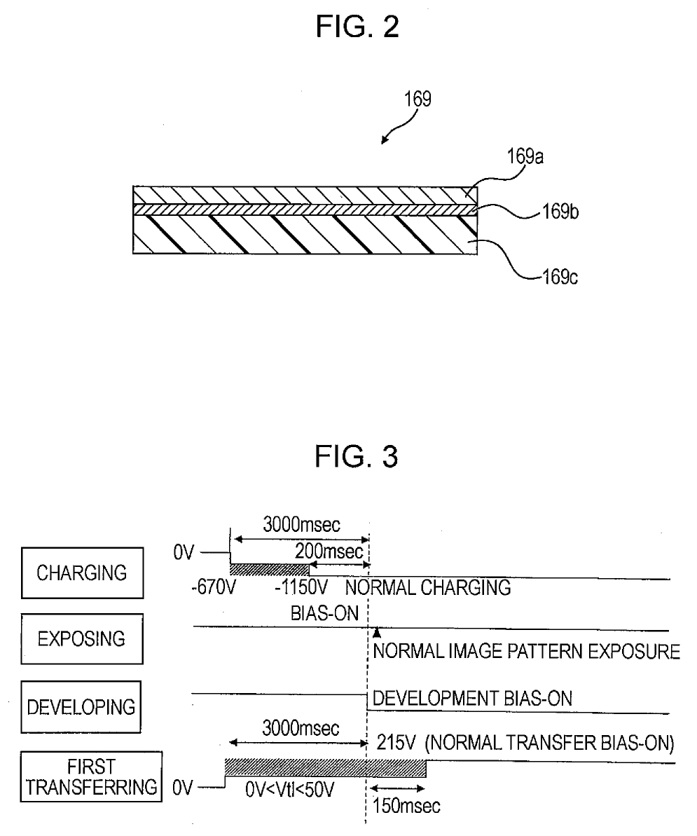

FIG. 2 is a sectional view illustrating the first transfer belt 169. As shown in FIG. 2, the first transfer belt 169 is formed of at least 3 layers with an outermost layer 169a on the outside, an intermediate layer 169b, and an innermost layer 169c on the inner side. The outermost layer 169a is made of tin, fluorine, and urethane, the intermediate layer 169b is made of tartar, and the innermost layer 169c is made of PET. It is desirable that resistance values satisfy a resistance value relation of the innermost layer>the outermost layer>the intermediate layer. For example, resistivity of the outermost layer 169a can be about 10⁹ Ω·cm, resistivity of the intermediate layer 169b can be about 10⁻² Ω·cm, and resistivity of the innermost layer 169c can be about 10¹⁵ Ω·cm.

FIG. 3 is a diagram illustrating timing charts of charging, exposing, developing, and first transferring operations in the image forming apparatus according to the first embodiment. In FIG. 3, a dotted line in a vertical direction indicates a time point when a development bias is applied.

In the first embodiment, as a first bias, a bias of −670 V is first applied in advance to a charging member 168 by a charging bias controller before about 3000 msec from the time the development bias is turned ON. In addition, the photosensitive drum 165 is made transferred and a bias in the range of 0 V<Vₜ₁<50 V is applied to the first transfer belt 169 by a transfer bias controller. In the first embodiment, the first bias applied to the first transfer belt 169 is 10 V.

Subsequently, immediately before a position at which an image is formed on the photosensitive drum 165 passes the charging member 168 before about 200 msec from the time the development bias is turned ON, a second regular bias is applied to the charging member 168 and the photosensitive drum 165 is charged to −1150 V by the charging bias controller.

In addition, the development bias is turned ON and a regular image pattern is exposed to light. Subsequently, immediately before a position at which the image is formed on the photosensitive drum 165 reaches a nip portion between the photosensitive drum 165 and the first transfer belt 169 after about 150 msec from the time when the development bias is turned ON, as a second regular bias, a bias of 215 V is applied to the first transfer belt 169 by the transfer bias controller.

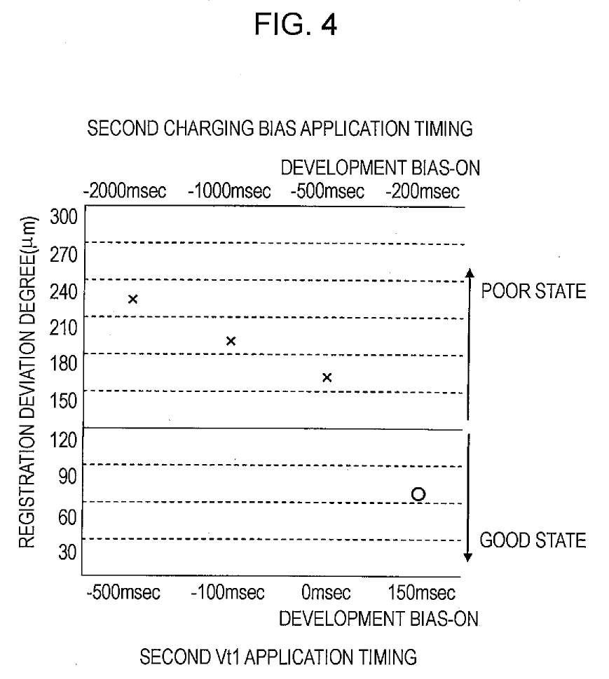

FIG. 4 is a diagram illustrating a graph in which the first embodiment is compared with other examples. Table 1 shows registration deviation and the image determination of the examples. When the registration deviation is less than 120 μm, the image determination is good, which is denoted by a sign O. When the registration deviation is 120 μm or more, the image determination is poor, which is denoted by a sign X.

TABLE 1

| | Registration deviation | |
|---|---|---|
| | (sub-scanning) | determination |
| Example 1 | 70 | O |
| Comparative Example 1 | 230 | X |
| Comparative Example 2 | 190 | X |
| Comparative Example 3 | 160 | X |

In Example 1, a printing test was performed as follows, That is, immediately before the position at which the image was formed on the photosensitive drum 165 passed the charging member 168 before about 200 msec from the time development bias was turned ON, as the second regular bias, a bias of −1150 V was applied to the charging member 168 by the charging bias controller and the photosensitive drum 165 was charged. In addition, immediately before the position at which the image was formed on the photosensitive drum 165 reached the nip portion between the photosensitive drum 165 and the first transfer belt 169 after about 150 msec from the time the development bias was turned ON, as the second regular bias, a bias of 215 V was applied to the first transfer belt 169 by the transfer bias controller. In Example 1, the registration deviation was about 70 μm.

Next, Comparative Examples will be described. In Comparative Example 1, a printing test was performed as follow. That is, before about 2000 msec from the time development bias was turned ON, as the second regular bias, a bias of −1150 V was applied to the charging member 168 by the charging bias controller and the photosensitive drum 165 was charged. In addition, before about 500 msec from the time the development bias was turned ON, as the second regular bias, a bias of 215 V was applied to the first transfer belt 169 by the transfer bias controller. In Comparative Example 1, the registration deviation was about 230 μm.

In Comparative Example 2, a printing test was performed as follow. That is, before about 1000 msec from the time development bias was turned ON, as the second regular bias, a bias of −1150 V was applied to the charging member 168 by the charging bias controller and the photosensitive drum 165 was charged. In addition, before about 100 msec from the time the development bias was turned ON, as the second regular bias, a bias of 215 V was applied to the first transfer belt 169 by the transfer bias controller. In Comparative Example 2, the registration deviation was about 190 μm.

In Comparative Example 3, a printing test was performed as follow. That is, before about 500 msec from the time development bias was turned ON, as the second regular bias, a bias of −1150 V was applied to the charging member 168 by the charging bias controller and the photosensitive drum 165 was charged. In addition, when the time the development bias was turned ON, as the second regular bias, a bias of 215 V was applied to the first transfer belt 169 by the transfer bias controller. In Comparative Example 3, the registration deviation was about 160 μm.

In this way, in the image forming apparatus according to this embodiment, it is possible to reduce the registration deviation, maintain high transfer efficiency, and also obtain a high-quality image.

The charging bias controller applies the first charging bias in advance, and then applies the second charging bias larger than the first charging bias immediately before the position at which the image is formed on the photosensitive member 165 passes the charging member 168. Accordingly, before the developer bias is turned ON, the image remaining on the photosensitive member 165 can be eliminated in advance. As a result, it is possible to obtain the high-quality image and achieve low power consumption in a portion indicated by oblique lines shown in FIG. 3.

Additionally, the transfer bias controller applies the first transfer bias in advance, and then applies the second transfer bias larger than the first transfer bias immediately before the position at which the image is formed on the photosensitive member 165 passes the nip portion between the photosensitive drum 165 and the first transfer belt 169. As a result, the power supply is stabilized, and thus it is possible to obtain the high-quality image and achieve low power consumption in the portion indicated by oblique lines shown in FIG. 3.

The first transfer belt 169 is formed of the first transfer belt 169 with two or more. Accordingly, since minute gap discharge before the transfer operation is suppressed and transfer electric field is sufficiently applied, the transfer efficiency can be improved. As a result, it is possible to obtain the high-quality image.

The first transfer belt 169 has the outermost layer 169a on the outside, the innermost layer 169c on the inner side, and the intermediate layer 169b between the outermost layer 169a and the innermost layer 169c. Resistance values of the layers of the first transfer belt 169 satisfy a resistance value relation of the innermost layer>the outermost layer>the intermediate layer. Accordingly, the transfer efficiency is further improved, and therefore it is possible to obtain the higher-quality image.

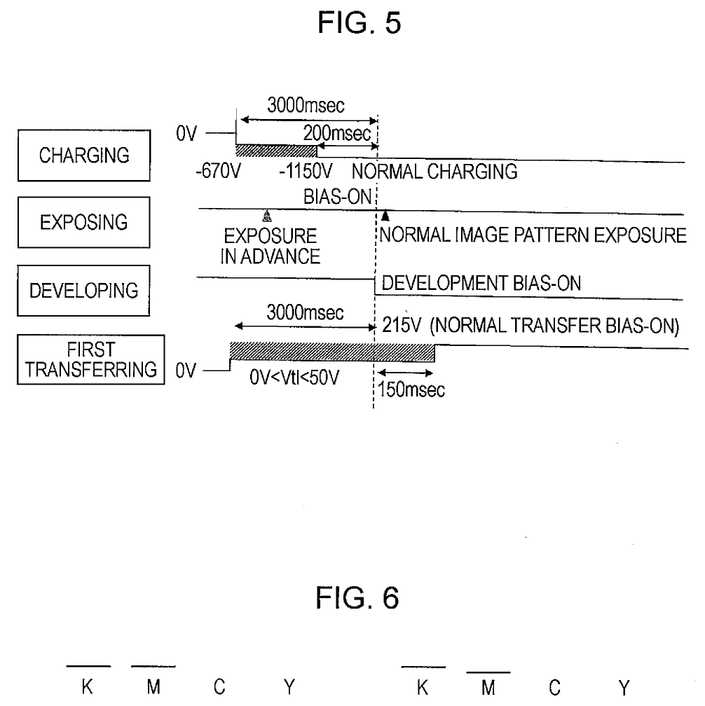

FIG. 5 is a diagram illustrating timing charts of charging, exposing, developing, and first transferring operations according to the second embodiment. In the second embodiment, in addition to the charging and first transferring operations, the exposing operation will be described. In FIG. 5, a dotted line in a vertical direction indicates a time point when a development bias is applied.

In the second embodiment, as a first bias, a bias of −670 V is first applied in advance to a charging member 168 by a charging bias controller before about 3000 msec from the time a development bias is turned ON, a photosensitive drum 165 is made transferred, a bias in the range of 0 V<Vₜ₁<50 V is applied to a first transfer belt 169 by a transfer bias controller. In the first embodiment, the first bias applied to the first transfer belt 169 is 10 V.

Next, before the development bias is turned ON, the photosensitive drum 165 is exposed in advance by the image forming member 167. Subsequently, immediately before a position at which the image is formed on the photosensitive drum 165 passes the charging member 168 before about 200 msec from the time when the development bias is turned ON, a second regular bias is applied to the charging member 168 and the photosensitive drum 165 is charged to −1150 V by the transfer bias controller.

In addition, the development bias is turned ON and a regular image pattern is exposed to light. Subsequently, immediately before a position at which the image is formed on the photosensitive drum 165 reaches a nip portion between the photosensitive drum 165 and the first transfer belt 169 after about 150 msec from the time when the development bias is turned ON, as a second regular bias, a bias of 215 V is applied to the first transfer belt 169 by the transfer bias controller.

The image forming apparatus and the image formation method according to the embodiments of the invention have been described above. However, the invention is not limited thereto, but may be modified in various forms.

The entire disclosure of Japanese Patent Application No. 2006-333143, filed Dec. 11, 2006 is expressly incorporated by reference herein.

What is claimed is:

1. An image forming apparatus comprising:
an image supporting member;
a charging member charging the image supporting member;
an image forming member forming a latent image on the image supporting member;
a developer supporting member developing the latent image on the image supporting member;
a transfer member to which the developed image is transferred;
a charging bias controller applying a charging bias immediately before a position at which the image is formed on the image supporting member in a printing operation passes the charging member; and
a transfer bias controller applying a transfer bias immediately before the position at which the image is formed on the image supporting member in the printing operation reaches a nip portion between the image supporting member and the transfer member.

2. The image forming apparatus according to claim 1, wherein the charging bias controller applies a first charging bias in advance and applies a second charging bias larger than the first charging bias immediately before the position at which the image is formed on the image supporting member in the printing operation passes the charging member.

3. The image forming apparatus according to claim 1, wherein the transfer bias controller applies a first transfer bias in advance and applies a second transfer bias larger than the first transfer bias immediately before the position at which the image is formed on the image supporting member in the printing operation reaches the nip portion between the image supporting member and the transfer member.

4. The image forming apparatus according to claim 1, further comprising an image forming controller performing an exposing operation to the image forming member in advance immediate before the position at which the image is formed on the image supporting member in the printing operation passes the image forming member.

5. The image forming apparatus according to claim 1, wherein the transfer member is formed of a transfer belt with two or more layers.

6. The image forming apparatus according to claim 1, wherein the transfer member has an innermost layer on the inside, an outermost layer on the outside, and an intermediate layer between the innermost layer and the outermost layer, and
wherein resistance values of the layers of the transfer member satisfy a resistance value relation of the innermost layer>the outermost layer>the intermediate layer.

7. An image forming method comprising:
applying a charging bias immediately before a position at which an image is formed on an image supporting member passes a charging member; and
applying a transfer bias immediately before the position at which the image is formed on the image supporting member reaches a nip portion between the image supporting member and a transfer member.

8. The image forming method according to claim 7, further comprising:
applying a first charging bias in advance; and
applying a second charging bias larger than the first charging bias immediately before the image is formed on the image supporting member passes the charging member.

9. The image forming method according to claim 7, further comprising:
applying a first transfer bias in advance; and
applying a second transfer bias larger than the first transfer bias immediately before the image is formed on the image supporting member reaches the transfer member.

10. The image forming method according to claim 7, further comprising:
performing an exposing operation to an image forming member in advance before the position at which an image is formed on the image supporting member passes the image forming member.
